(19) United States
(12) Patent Application Publication
(10) Pub. No.: US 2024/0247698 A1
(43) Pub. Date: Jul. 25, 2024

(54) UNDERLAYER MATERIAL AND FRICTION MEMBER

(71) Applicant: AKEBONO BRAKE INDUSTRY CO., LTD., Chuo-ku, Tokyo (JP)

(72) Inventors: Kentaro OWA, Chuo-ku, Tokyo (JP); Motoyuki MIYAJI, Chuo-ku, Tokyo (JP); Hiroshi YAMAMOTO, Chuo-ku, Tokyo (JP); Yuta WATANABE, Chuo-ku, Tokyo (JP); Kenta KIMURA, Chuo-ku, Tokyo (JP)

(73) Assignee: AKEBONO BRAKE INDUSTRY CO., LTD., Chuo-ku, Tokyo (JP)

(21) Appl. No.: 18/293,037

(22) PCT Filed: Jul. 25, 2022
(86) PCT No.: PCT/JP2022/028664

§ 371 Date: Jan. 29, 2024

(30) Foreign Application Priority Data
Jul. 30, 2021 (JP) 2021-125660

(51) Int. Cl. F16D 69/02; F16D 69/00

(52) U.S. Cl. CPC F16D 69/02; F16D 2069/005

(57) ABSTRACT

The present invention relates to an underlayer material to be used in a friction member, the underlayer material including a plant-derived resin, in which the friction member includes a friction material and a pressure plate, and the friction material includes a friction modifier, a binder, and a fiber base material. The plant-derived resin may be a lignin-modified phenol resin.

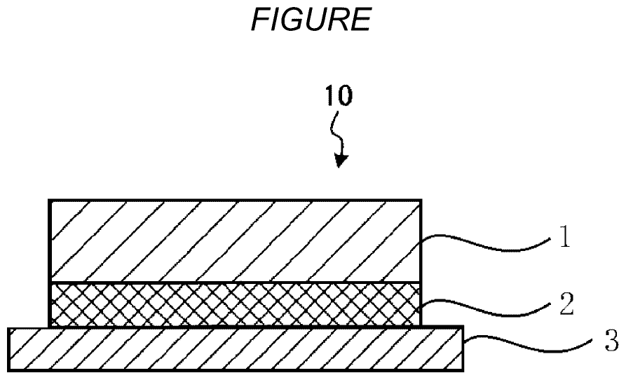

### TECHNICAL FIELD

The present invention relates to an underlayer material for a friction member to be used in automobiles, railroad vehicles, industrial machinery, and the like, and a friction member using the underlayer material.

### BACKGROUND ART

In the related art, a friction member is required to have various performances, and one of them is, for example, less noise (brake squeal) generated by a braking operation.

As a technique of preventing the brake squeal, for example, Patent Literature 1 discloses a friction material containing a fiber base material, a binder, an abrasive, and a friction modifier, in which silane coupling agent-dispersed silicone rubber particles in which a silane coupling agent is dispersed inside silicone rubber particles are contained as the friction modifier.

### CITATION LIST

### Patent Literature

Patent Literature 1: JP2012-107205A

### SUMMARY OF INVENTION

### Technical Problem

However, according to studies of the present inventors, there is a concern that strength and heat resistance deteriorate in the technique disclosed in Patent Literature 1.

The present invention has been made in view of the above circumstances in the related art, and an object to be solved is to provide an underlayer material from which a friction member that has high strength and high heat resistance and that is less likely to generate a brake squeal can be provided.

### Solution to Problem

As a result of intensive studies, the present inventors have found that when an underlayer material contains a plant-derived resin, the above problem can be solved. Thus, the present invention has been completed.

That is, the present invention relates to the following (1) to (5).
(1) An underlayer material to be used in a friction member, the underlayer material including a plant-derived resin, in which the friction member includes a friction material and a pressure plate, and the friction material includes a friction modifier, a binder, and a fiber base material.
(2) The underlayer material according to (1), in which the plant-derived resin is a lignin-modified phenol resin.
(3) The underlayer material according to (1) or (2), in which a content of the plant-derived resin is 5 mass % to 15 mass %.
(4) A friction member including:
   a friction material;
   the underlayer material according to any one of (1) to (3); and
   a pressure plate, in this order.
(5) The friction member according to (4), in which the friction material is free of a copper component.

### Advantageous Effects of Invention

A friction member using the underlayer material according to the present invention has high strength and high heat resistance, and is less likely to generate a brake squeal.

### BRIEF DESCRIPTION OF DRAWINGS

The FIGURE is a schematic cross-sectional view showing a structural example of a friction member according to the present embodiment.

### DESCRIPTION OF EMBODIMENTS

Hereinafter, the present invention will be described in detail, but these show examples of desirable embodiments, and the present invention is not specified in these contents.

An underlayer material according to the present embodiment is to be used in a friction member.

### [Friction Member]

As shown in the FIGURE, a friction member 10 includes a friction material 1, an underlayer material 2, and a pressure plate 3 in this order.

### (Friction Material)

The friction material contains a friction modifier, a binder, and a fiber base material.

### <Friction Modifier>

The friction modifier to be used in the friction material is used to impart desired friction properties such as wear resistance, heat resistance, and fade resistance to the friction material.

Examples of the friction modifier include an inorganic filler, an organic filler, an abrasive, a lubricant, and a metal powder.

Examples of the inorganic filler include inorganic materials, for example, titanates such as potassium titanate, lithium titanate, lithium potassium titanate, sodium titanate, calcium titanate, magnesium titanate, and magnesium potassium titanate; barium sulfate, calcium carbonate, calcium hydroxide, vermiculite, and mica. These may be used alone or in combination of two or more thereof.

The inorganic filler is used in an amount of preferably 30 mass % to 80 mass %, and more preferably 40 mass % to 70 mass %, in the entire friction material.

Examples of the organic filler include various rubber powders (a raw rubber powder, a tire powder, etc.), rubber dust, resin dust, cashew dust, tire tread, and melamine dust. These may be used alone or in combination of two or more thereof.

The organic filler is used in an amount of preferably 1 mass % to 15 mass %, and more preferably 1 mass % to 10 mass %, in the entire friction material.

Examples of the abrasive include zirconium oxide, alumina, silica, magnesium oxide, zirconia, zirconium silicate, chromium oxide, triiron tetroxide (Fe₃O₄), and chromite. These may be used alone or in combination of two or more thereof.

The abrasive is used in an amount of preferably 1 mass % to 20 mass %, and more preferably 3 mass % to 15 mass %, in the entire friction material.

Examples of the lubricant include graphite, coke, antimony trisulfide, molybdenum disulfide, tin sulfide, and polytetrafluoroethylene (PTFE). These may be used alone or in combination of two or more thereof.

The lubricant is used in an amount of preferably 1 mass % to 20 mass %, and more preferably 3 mass % to 15 mass %, in the entire friction material.

Examples of the metal powder include powders of aluminum, tin, zinc, and copper. These may be used alone or in combination of two or more thereof.

The metal powder is used in an amount of preferably 1 mass % to 10 mass %, and more preferably 1 mass % to 5 mass %, in the entire friction material.

From the viewpoint of sufficiently imparting the desired friction properties to the friction material, the friction modifier is used in an amount of preferably 60 mass % to 90 mass %, and more preferably 70 mass % to 90 mass %, in the entire friction material.

### <Binder>

As the binder to be used in the friction material, various commonly used binders can be used. Specific examples thereof include thermosetting resins such as a phenol resin, various elastomer-modified phenol resins, a melamine resin, an epoxy resin, and a polyimide resin.

Examples of the elastomer-modified phenol resins include an acrylic rubber-modified phenol resin, a silicone rubber-modified phenol resin, and a nitrile rubber (NBR)-modified phenol resin. These may be used alone or in combination of two or more thereof.

From the viewpoint of moldability of the friction material, the binder is used in an amount of preferably 1 mass % to 20 mass %, and more preferably 3 mass % to 15 mass %, in the entire friction material.

### <Fiber Base Material>

Examples of the fiber base material to be used in the friction material include an organic fiber and an inorganic fiber. These fiber base materials may be used alone or in combination of two or more thereof.

Examples of the organic fiber include an aromatic polyamide (aramid) fiber and a flame-resistant acrylic fiber.

Examples of the inorganic fiber include a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, and a SiO₂—MgO—SrO-based fiber, and biosoluble rock wool.

From the viewpoint of ensuring the strength of the friction material, the fiber base material is used in an amount of preferably 3 mass % to 30 mass %, and more preferably 5 mass % to 20 mass %, in the entire friction material.

From the viewpoint of reducing an environmental load, the friction material is preferably free of a copper component.

### (Underlayer Material)

The underlayer material according to the present embodiment preferably contains a friction modifier, a binder, and a fiber base material.

### <Friction Modifier>

Examples of the friction modifier to be used in the underlayer material include an inorganic filler, an organic filler, an abrasive, a lubricant, and a metal powder.

Examples of the inorganic filler include inorganic materials, for example, titanates such as potassium titanate, lithium titanate, lithium potassium titanate, sodium titanate, calcium titanate, magnesium titanate, and magnesium potassium titanate; barium sulfate, calcium carbonate, calcium hydroxide, vermiculite, and mica. These may be used alone or in combination of two or more thereof.

The inorganic filler is used in an amount of preferably 20 mass % to 50 mass %, and more preferably 25 mass % to 45 mass %, in the entire underlayer material.

Examples of the organic filler include various rubber powders (a raw rubber powder, a tire powder, etc.), rubber dust, resin dust, cashew dust, tire tread, and melamine dust. These may be used alone or in combination of two or more thereof.

The organic filler is used in an amount of preferably 1 mass % to 15 mass %, and more preferably 1 mass % to 10 mass %, in the entire underlayer material.

Examples of the abrasive include zirconium oxide, alumina, silica, magnesium oxide, zirconia, zirconium silicate, chromium oxide, triiron tetroxide (Fe₃O₄), and chromite. If necessary, these may be used alone or in combination of two or more thereof.

In a case of blending the abrasive in the underlayer material, the abrasive is used in an amount of preferably 1 mass % to 20 mass %, and more preferably 3 mass % to 15 mass %, in the entire underlayer material.

Examples of the lubricant include graphite, coke, antimony trisulfide, molybdenum disulfide, tin sulfide, and polytetrafluoroethylene (PTFE). If necessary, these may be used alone or in combination of two or more thereof.

In a case of blending the lubricant in the underlayer material, the lubricant is used in an amount of preferably 1 mass % to 20 mass %, and more preferably 3 mass % to 15 mass %, in the entire underlayer material.

Examples of the metal powder include powders of aluminum, tin, and zinc. These may be used alone or in combination of two or more thereof.

The metal powder is used in an amount of preferably 1 mass % to 10 mass %, and more preferably 1 mass % to 5 mass %, in the entire underlayer material.

The friction modifier is used in an amount of preferably 20 mass % to 70 mass %, and more preferably 30 mass % to 60 mass %, in the entire underlayer material.

### <Binder>

The underlayer material according to the present embodiment contains a plant-derived resin as the binder.

The plant-derived resin has an irregular and highly complex chemical structure. As a result, it is considered that the friction member including the underlayer material according to the present embodiment containing the plant-derived resin has high strength and high heat resistance, and is less likely to generate a brake squeal.

Examples of the plant-derived resin include a lignin-modified phenol resin, a polylactic acid, an esterified starch, a polyhydroxybutyric acid, and polytrimethylene terephthalate. Among them, from the viewpoint of heat resistance, preferred is a lignin-modified phenol resin having functions derived from lignin, which is an irregular and highly complex polyphenol chemical structure.

The plant-derived resin is used in an amount of preferably 5 mass % to 15 mass %, and more preferably 10 mass % to 15 mass %, in the entire underlayer material. When the content of the plant-derived resin is 5 mass % or more, the strength and the heat resistance of the obtained friction member can be increased, and the generation of the brake squeal can be further prevented. In addition, when the content of the plant-derived resin is 15 mass % or less, a sufficient amount of other components can be contained in the underlayer material.

As other binders to be used in the underlayer material, various commonly used binders can be used. Specific examples thereof include thermosetting resins such as a phenol resin, a modified phenol resin, a melamine resin, an epoxy resin, and a polyimide resin.

Examples of the modified phenol resin include an acrylic-modified phenol resin, an aralkyl-modified phenol resin, a silicone rubber-modified phenol resin, and a nitrile rubber (NBR)-modified phenol resin. These may be used alone or in combination of two or more thereof.

From the viewpoint of moldability of the underlayer material, the binder is used in an amount of preferably 1 mass % to 25 mass %, and more preferably 5 mass % to 20 mass %, in the entire underlayer material.

### <Fiber Base Material>

Examples of the fiber base material to be used in the underlayer material include an organic fiber and an inorganic fiber. These fiber base materials may be used alone or in combination of two or more thereof.

Examples of the organic fiber include an aromatic polyamide (aramid) fiber and a flame-resistant acrylic fiber.

Examples of the inorganic fiber include a steel fiber, a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, and a SiO₂—MgO—SrO-based fiber, and biosoluble rock wool.

From the viewpoint of ensuring the strength of the underlayer material, the fiber base material is used in an amount of preferably 10 mass % to 50 mass %, and more preferably 15 mass % to 45 mass %, in the entire underlayer material.

From the viewpoint of reducing an environmental load, the underlayer material is preferably free of a copper component.

### (Pressure Plate)

The pressure plate is molded by sheet metal press working or the like. A material of the pressure plate is not particularly limited, and known iron metal materials can be used. As the known iron metal materials, for example, hot-rolled steel sheets for automobile structures such as SAPH400 and SAPH440, and workable hot-rolled high-strength steel sheets for automobiles such as SPFH590 can be used.

### [Method for Producing Friction Material, Underlayer Material, and Friction Member]

The friction material, the underlayer material, and the friction member can be produced by a known production process, and, for example, can be produced by blending the above components, and subjecting the blended material to steps such as preforming, hot molding, heating, and grinding according to a usual production method.

A method of producing the friction member including the friction material, the underlayer material, and the pressure plate generally includes the following steps:
(a) a step of molding a pressure plate into a predetermined shape by using a sheet metal press;
(b) a step of applying a degreasing treatment, a chemical conversion treatment, and a primer treatment to the above pressure plate and coating the above pressure plate with an adhesive;
(c) a step of blending raw materials for a friction material and raw materials for an underlayer material, sufficiently homogenizing them by mixing, successively charging the mixed raw materials into a mold, and molding the mixed raw materials at room temperature under a predetermined pressure to prepare a preformed body;
(d) a hot molding step of integrally fixing the preformed body and the pressure plate coated with the above adhesive by applying a predetermined temperature and pressure (molding temperature: 130° C. to 180° C., molding pressure: 30 MPa to 80 MPa, molding time: 2 minutes to 10 minutes); and
(e) a step of performing after-cure (150° C. to 300° C., 1 hour to 5 hours) and finally performing finishing treatments such as grinding, scorching, and painting.

A thickness of the friction material is preferably 4 mm to 15 mm, and more preferably 6 mm to 13 mm.

A thickness of the underlayer material is preferably 1 mm to 4 mm, and more preferably 1 mm to 3 mm.

### EXAMPLES

The present invention will be specifically described by way of the following Examples, but the present invention is not limited thereto.

### Examples 1 to 3 and Comparative Examples 1 to 3

Blending materials for the friction material and blending materials for the underlayer material shown in Tables 2 and 3 were separately charged into a mixer and mixed at room temperature for 4 minutes to obtain a blending material mixture of the friction material and a blending material mixture of the underlayer material.

The obtained mixture was subjected to the following steps of (i) preforming, (ii) hot molding, and (iii) heat treatment and scorching to prepare a friction material.

### (i) Preforming

The blending material mixture of the friction material and the blending material mixture of the underlayer material were successively charged into a mold of a preforming press and molded at room temperature at 20 MPa for 10 seconds to prepare a preformed body.

### (ii) Hot Molding

The preformed body was charged into a hot molding mold, metal plates (pressure plates) coated with an adhesive in advance were stacked, and hot press molding was performed at 150° C. and 40 MPa for 5 minutes.

(iii) Heat Treatment and Scorching

The hot-press molded body was subjected to a heat treatment at 250° C. for 3 hours and then the surface thereof was grinded.

Next, the surface of the hot-press molded body was scorched and finished by a painting to obtain a friction member.

The friction members obtained in Examples 1 to 3 and Comparative Examples 1 to 3 were evaluated for the strength, the heat resistance, and the brake squeal by the following methods. The results are shown in Tables 2 and 3.

### <Strength>

Shear strength of the friction member was measured at 25° C. and 300° C. according to JIS D 4422 (adhesion area: 55 cm²). The measured value was a shear force per unit area (N/cm²) obtained by dividing a stress at shear fracture by the adhesion area between the pressure plate and the underlayer material.

The calculated shear force was evaluated based on the following criteria.

(25° C.)
⊚: 550 N/cm² or more
∘: 500 N/cm² or more and less than 550 N/cm²
Δ: 450 N/cm² or more and less than 500 N/cm²
x: less than 450 N/cm²

(300° C.)
⊚: 350 N/cm² or more
∘: 300 N/cm² or more and less than 350 N/cm²
Δ: 250 N/cm² or more and less than 300 N/cm²
x: less than 250 N/cm²

### <Heat Resistance>

Based on test conditions shown in Table 1, the friction member obtained above was evaluated using a full size dynamometer. That is, repeated fading (speed: 100 km/h→0 km/h, deceleration: 10 to 15 times at 4.4 m/s²) and recovery (speed: 50 km/h→0 km/h, deceleration: 15 times at 3.0 m/s²) caused a rapid heat change, and whether cracks were generated on a side surface of the friction member due to a difference in heat conduction between the friction material and the underlayer material due to the heat change was confirmed.

Other conditions were as follows.

Pad area: 37 cm², disc diameter: 300 mm, inertia: 100 kg·m²

TABLE 1

| | | Disc rotor | | | Control | |
|---|---|---|---|---|---|---|
| | | braking initial | Initial speed | Final speed | Deceleration | Braking times |
| No. | Item | temperature [° C.] | [km/h] | [km/h] | [m/s²] | [times] |
| 1 | Burnish | 95 | 50 | 0 | 3.0 | 3 |
| 2 | First fading | 65 | 100 | 0 | 4.4 | 10 |
| 3 | Recovery | — | 50 | 0 | 3.0 | 15 |
| 4 | Second fading | 65 | 100 | 0 | 4.4 | 15 |
| 5 | Recovery | — | 50 | 0 | 3.0 | 15 |
| 6 | Third fading | 65 | 100 | 0 | 4.4 | 10 |
| 7 | Recovery | — | 50 | 0 | 3.0 | 15 |
| 8 | Fourth fading | 65 | 100 | 0 | 4.4 | 15 |
| 9 | Recovery | — | 50 | 0 | 3.0 | 15 |

The generated cracks were evaluated based on the following criteria.
⊚: no cracks are generated
∘: cracks having a width of less than 0.1 mm are generated
Δ: cracks having a width of 0.1 mm or more and less than 0.2 mm are generated
x: cracks having a width of 0.2 mm or more are generated

### <Brake Squeal>

Using the friction member obtained above, an actual vehicle squeal test was performed in accordance with JASO C402 (Actual Vehicle Test Method for Brake Pads for Passenger Vehicles) on an actual vehicle (vehicle type: SUV AT car, vehicle weight: 2000 kg) to obtain a generation rate of a brake squeal.

The obtained generation rate of the brake squeal was evaluated based on the following criteria.
⊚: no squeals are generated
∘: greater than 0% and less than 5%
Δ: 5% or more and less than 10%
x: 10% or more

TABLE 2

| | | | (mass %) | | |
|---|---|---|---|---|---|
| | | | Example | | |
| | | | 1 | 2 | 3 |
| Friction | Binder | Straight phenol resin | 8 | 8 | 8 |
| material | Friction | Cashew dust | 5 | 5 | 5 |
| | modifier | Rubber dust | 2 | 2 | 2 |
| | | Graphite | 6 | 6 | 6 |
| | | Calcium hydroxide | 3 | 3 | 3 |
| | | Mica | 5 | 5 | 5 |
| | | Potassium titanate | 18 | 18 | 18 |
| | | Barium sulfate | 31 | 31 | 31 |
| | | zirconium silicate | 6 | 6 | 6 |
| | | Triiron tetroxide | 5 | 5 | 5 |
| | | Zinc powder | 2 | 2 | 2 |
| | Fiber | Aramid fiber | 5 | 5 | 5 |
| | base | Biosoluble inorganic | 4 | 4 | 4 |
| | material | fiber | | | |
| | Total | | 100 | | |
| Underlayer | Binder | Straight phenol resin | 10 | 5 | — |
| material | | Acrylic-modified | — | — | — |
| | | phenol resin | | | |
| | | Lignin-modified | 5 | 10 | 15 |
| | | phenol resin | | | |
| | Friction | Rubber dust | 6 | 6 | 6 |
| | modifier | Calcium hydroxide | 3 | 3 | 3 |
| | | Barium sulfate | 25 | 25 | 25 |
| | | Calcium carbonate | 5 | 5 | 5 |
| | | Zinc powder | 3 | 3 | 3 |
| | Fiber | Aramid fiber | 6 | 6 | 6 |
| | base | Biosoluble inorganic | 2 | 2 | 2 |
| | material | fiber | | | |
| | | Steel fiber | 35 | 35 | 35 |
| | Total | | 100 | | |
| Evaluation | Shear | 25° C. [N/cm²] | 530 | 544 | 551 |
| | strength | 300° C. [N/cm²] | 340 | 349 | 370 |
| | Heat | Crack width [mm] | Less | No | No |
| | resistance | | than 0.1 | | |
| | Brake | Squeal generation | 3 | No | No |
| | squeal | rate [%] | | | |

| | | | | |
|---|---|---|---|---|
| Determination | Shear strength (25° C.) | ◯ | ◯ | ⊚ |
| | Shear strength (300° C.) | ◯ | ◯ | ⊚ |
| | Heat resistance | ◯ | ⊚ | ⊚ |
| | Brake squeal | ◯ | ⊚ | ⊚ |

TABLE 3

| | | | (mass %) | | |
|---|---|---|---|---|---|
| | | | Comparative Example | | |
| | | | 1 | 2 | 3 |
| Friction | Binder | Straight phenol resin | 8 | 8 | 8 |
| material | Friction modifier | Cashew dust | 5 | 5 | 5 |
| | | Rubber dust | 2 | 2 | 2 |
| | | Graphite | 6 | 6 | 6 |
| | | Calcium hydroxide | 3 | 3 | 3 |
| | | Mica | 5 | 5 | 5 |
| | | Potassium titanate | 18 | 18 | 18 |
| | | Barium sulfate | 31 | 31 | 31 |
| | | zirconium silicate | 6 | 6 | 6 |
| | | Triiron tetroxide | 5 | 5 | 5 |
| | | Zinc powder | 2 | 2 | 2 |
| | Fiber base material | Aramid fiber | 5 | 5 | 5 |
| | | Biosoluble inorganic fiber | 4 | 4 | 4 |
| | Total | | 100 | | |
| Underlayer | Binder | Straight phenol resin | 15 | — | 10 |
| material | | Acrylic-modified phenol resin | — | 15 | 5 |
| | | Lignin-modified phenol resin | — | — | — |
| | Friction modifier | Rubber dust | 6 | 6 | 6 |
| | | Calcium hydroxide | 3 | 3 | 3 |
| | | Barium sulfate | 25 | 25 | 25 |
| | | Calcium carbonate | 5 | 5 | 5 |
| | | Zinc powder | 3 | 3 | 3 |
| | Fiber base material | Aramid fiber | 6 | 6 | 6 |
| | | Biosoluble inorganic fiber | 2 | 2 | 2 |
| | | Steel fiber | 35 | 35 | 35 |
| | Total | | 100 | | |
| Evaluation | Shear strength | 25° C. [N/cm²] | 510 | 492 | 498 |
| | | 300° C. [N/cm²] | 318 | 293 | 310 |
| | Heat resistance | Crack width [mm] | 0.1 | 0.1 to 0.2 | 0.1 |
| | Brake squeal | Squeal generation rate [%] | 4 | 4 | 4 |
| Determination | | Shear strength (25° C.) | ◯ | Δ | Δ |
| | | Shear strength (300° C.) | ◯ | Δ | ◯ |
| | | Heat resistance | Δ | x | Δ |
| | | Brake squeal | ◯ | ◯ | ◯ |

From the results in Tables 2 and 3, it can be seen that the friction members obtained from the underlayer materials according to Examples 1 to 3 have high strength and high heat resistance, and are less likely to generate a brake squeal.

Although the present invention has been described in detail with reference to a specific embodiment, it will be apparent to those skilled in the art that various changes and modifications can be made without departing from the spirit and the scope of the present invention. The present application is based on a Japanese Patent Application (Japanese Patent Application No. 2021-125660) filed on Jul. 30, 2021, and the content thereof is incorporated herein by reference.

### REFERENCE SIGNS LIST

1 friction material
2 underlayer material
3 pressure plate
10 friction member

1: An underlayer material to be used in a friction member, the underlayer material comprising a plant-derived resin, wherein
the friction member comprises a friction material and a pressure plate, and
the friction material comprises a friction modifier, a binder, and a fiber base material.

2: The underlayer material according to claim 1, wherein the plant-derived resin is a lignin-modified phenol resin.

3: The underlayer material according to claim 1, wherein a content of the plant-derived resin is 5 mass % to 15 mass %.

4: A friction member comprising:
a friction material;
the underlayer material according to claim 1; and
a pressure plate, in this order.

5: A friction member comprising:
a friction material;
the underlayer material according to claim 3; and
a pressure plate, in this order.

6: The friction member according to claim 4, wherein the friction material is free of a copper component.

7: The friction member according to claim 5, wherein the friction material is free of a copper component.
